(19) United States
(12) Patent Application Publication
(10) Pub. No.: US 2022/0143720 A1
(43) Pub. Date: May 12, 2022

(54) Reamer Having Blade Debris Removal and Drilling Direction Reversibility Features

(71) Applicants: David B. Wagner, Houston, TX (US); Jerald C. Shipley, Colombus, TX (US); Amar Patel, Houston, TX (US)

(72) Inventors: David B. Wagner, Houston, TX (US); Jerald C. Shipley, Colombus, TX (US); Amar Patel, Houston, TX (US)

(73) Assignee: Inrock Drilling Systems, Inc., Houston, TX (US)

(21) Appl. No.: 17/523,455

(22) Filed: Nov. 10, 2021

Related U.S. Application Data
(60) Provisional application No. 63/112,945, filed on Nov. 12, 2020.

(51) Int. Cl. B23D 77/02

(52) U.S. Cl. CPC B23D 77/02

(57) ABSTRACT

Embodiments of a reamer of the present invention generally include a body, one or more attachment members, one or more sub-body members that are reversibly attachable to the attachment members and contain one or more blades containing cutting elements, one or more nozzles, each disposed on the collar (tubular section) proximate a portion of the cutting structure, such that fluid flowing through a nozzle is directed tangentially along a series of cutting elements disposed along the cutting structure. Additional embodiments include sub-body members and/or attachment members that facilitate bi-directional excavation and/or rotational operation of the reamer. Embodiments of methods of using apparatuses of the present invention are also provided.

### CROSS-REFERENCE TO RELATED APPLICATIONS

This application claims the benefit of U.S. Provisional Application No. 63/112,945, filed on Nov. 12, 2020, which application is incorporated herein by reference as if reproduced in full below.

### STATEMENT REGARDING FEDERALLY SPONSORED RESEARCH OR DEVELOPMENT

Not applicable.

### BACKGROUND OF THE INVENTION

This invention relates to an apparatus and method for sub-surface Horizontal Directional Drilling (HDD). HDD is utilized to create an underground pathway without excavation at ground level. An example of HDD may be found in U.S. Pat. No. 5,242,026 to Deken, et al., which is incorporated herein by reference in its entirety. One type of apparatus utilized in HDD is a borehole cutter, also known as a “reamer.” Exampled reamers may be found in U.S. Pat. No. 6,386,302 to Beaton, and U.S. Pat. No. 10,428,586 to Wagner et al., which are incorporated herein by reference in their entirety.

### DESCRIPTION OF THE RELATED ART

Within the HDD industry, the underground pathways (bores or holes) are usually not straight and need to be steered to create the necessary profile to avoid surface and sub-surface obstacles. Typically, a bore is created by first constructing a pilot hole using guidance means and a downhole excavating assembly comprising a pilot bit or small-diameter reamer with a bend in or adjacent thereto to steer the bore in a desired direction. Typically, the excavating assembly is powered by an above-ground, motorized unit (rig) to provide rotational and/or downhole force. The pilot hole is then usually opened using a larger diameter tool, such as a reamer, in one or multiple passes to create a progressively larger diameter hole. The reamers can be pushed and/or pulled and do not require steering as they follow the profile of the original pilot hole.

A typical reamer will comprise several major components, including a collar, body and cutting elements. In one type of reamer, the cutting elements are of a type generally known as a “shear cutter.” The reamer is designed to concurrently apply load to and fracture the rock, as well as direct drilling fluid, such as mud or water, to flush the cuttings away and expose fresh rock to be drilled. A reamer may be comprised of tubular steel, with forged, cast and/or machined components, and steel plates.

In various embodiments, prior art reamers contain a body and collar that are designed to fit into the previously drilled hole so that the bore can be outwardly concentrically expanded in relation to the previously drilled hole. In operation, rotational engagement between the outer surface of the cutting elements and the rock being drilled results in fragments of the rock material being produced and disposed within the hole. In one aspect, some portion of these rock fragments (“debris”) accumulate along the cutting surfaces of the cutting elements. Such accumulation can diminish the cutting force of the reamer. Historically, reamers have been equipped with one or more nozzles through which a fluid, such as water, can be flowed to attempt to dislodge the rock fragments that have accumulated along the cutting surfaces, and flush cuttings away from the tool and clean the borehole. While prior art reamers containing such nozzles have demonstrated some ability to dislodge these rock fragments, it would be desirable to better maintain debris-free cutting surfaces to even further increase the efficiency of the bore expanding process.

Additionally, in operational use, reamers may be pushed or pulled through the pilot holes to outwardly concentrically expand the previously drilled hole. Historically, reamers have comprised structures that are functionally unidirectional; that is, the components of particular cutting elements are oriented such that the reamer functions to excavate rock if the reamer is displaced along the bore in one direction (e.g., “pushed”), but that same reamer will not function to excavate rock if that reamer is displaced along the bore in the opposite direction (e.g., “pulled”). Accordingly, for a given reaming operation, if a change in direction for excavating is desired (e.g., pushing to pulling, or vice versa), the reaming unit must be removed from the hole and the reamer switched out for a reamer comprising oppositely directionally orientated cutting elements before reaming in the opposite direction may be commenced. Such necessity for removing a reamer from the hole, exchanging it for another reamer having different cutting elements, and re-inserting the reamer into the hole to change reaming direction is cumbersome and time consuming. Thus, it would be desirable to provide a reamer that could more expediently excavate when either pushed or pulled.

### BRIEF SUMMARY OF THE INVENTION

Embodiments of an apparatus of the present invention generally include a reamer comprising one or more nozzles, each disposed on the collar (tubular section) proximate a reversibly attachable shear cutting sub-body, such that fluid flowing through a nozzle is directed tangentially along a series of cutting elements disposed along the sub-body. Embodiments of a method of utilizing an apparatus of the present invention are also provided.

Embodiments of an apparatus of the present invention generally include a reamer comprising one or more sub-bodies, wherein each sub-body, which comprises a series of cutting elements, is reversibly attachable to an attachment member that is attached to or integral with the body of the reamer. In one embodiment, the directional functioning of the reamer can be reversed by re-orienting the reamer and attaching oppositely functionalized sub-bodies to the attachment members. In one embodiment, the attachment of dually-functionalized sub-bodies to modified attachment members provides a reamer that can excavate either while being pulled or pushed or in either direction of rotation. Embodiments of a method of utilizing such apparatuses of the present invention are also provided.

### BRIEF DESCRIPTION OF THE DRAWINGS

FIG. 1 is a depiction of a portion of an embodiment of a reamer of the present invention.

FIG. 2 is a partially exploded view of an embodiment of a reamer of the present invention.

FIG. 3 is a depiction of the embodiment of a reamer of the present invention depicted in FIG. 2.

FIG. 4 is an end-on cross-sectional depiction of an embodiment of a reamer of the present invention.

FIGS. 5A-5D are schematic depictions of a portion of an embodiment of a reamer of the present invention.

FIG. 6 is a view of the embodiment of a reamer of the present invention depicted in FIG. 3 showing rotational and excavation direction.

FIG. 7 is a partially exploded view of the embodiment of a reamer of the present invention depicted in FIG. 6, wherein the reamer has been rotated 180 degrees and an oppositely oriented sub-body is utilized.

FIG. 8 is a partially exploded view of the embodiment of a reamer of the present invention depicted in FIG. 7 showing rotational and excavation direction.

FIG. 9 is a partially exploded view of an embodiment of a bi-directional reamer of the present invention.

FIG. 10 is a view of an embodiment of a bi-directional reamer of the present invention showing rotational and excavation directions.

FIG. 11 is a view of an embodiment of a bi-directional reamer of the present invention showing rotational and excavation directions.

FIG. 12 is a view of an embodiment of a bi-directional reamer of the present invention showing rotational and excavation directions.

### DETAILED DESCRIPTION OF EXEMPLARY EMBODIMENTS OF THE INVENTION

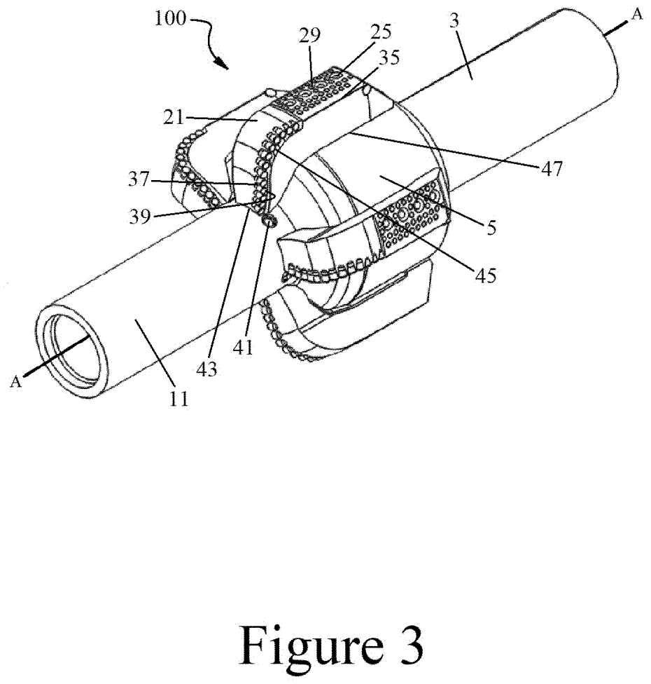

The exemplary embodiments are best understood by referring to the drawings with like numerals being used for like and corresponding parts of the various drawings. As used herein, longitudinal refers to the axis A-A identified in FIG. 3 (i.e., the axis of rotation of the reamer), and axial refers to a direction perpendicular to axis A-A of FIG. 3. The directions top, bottom, up, down, right, and left, as recited in this specification are used for descriptive purposes only, and other orientations are contemplated. In one aspect, as recited in herein, the term “up-hole” refers to a section of the bore which has already been excavated by the reamer during a given drilling operation, and the term “downhole” refers to a section of the bore which has not yet been excavated by the reamer during that drilling operation.

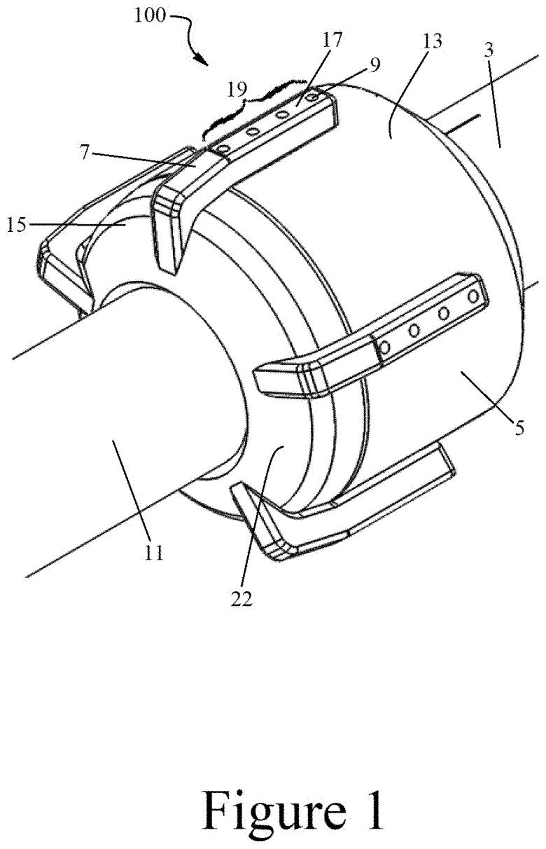

Referring to FIG. 1, a portion of an embodiment of a reamer 100 of the present invention is depicted. As shown in FIG. 1, the portion of reamer 100 depicted comprises an up-hole pipe section 3, body 5, attachment members 7 comprising attachment openings 9, and a downhole pipe section (collar) 11. In various embodiments, a reamer 100 may comprise one or more attachment members 7 spaced about an exterior surface 13 of body 5. In one embodiment, a reamer 100 comprises five attachment members 7 spaced evenly apart about exterior surface 13 of body 5, although the invention is not so limited and other numbers of attachment members 7 and/or spacing arrangements may be employed. In one embodiment, one or more of the attachment members 7 are positioned proximate a downhole end 15 of body 5, although as discussed below, other configurations are contemplated. In one embodiment, attachment members 7 may be fixedly attached to exterior surface 13, such as by welding thereto or other attachment means as would be understood by one skilled in the art. In another embodiment, attachment members 7 may be provided integral to body 5. In one embodiment (not shown), attachment members 7 may be removably attached to body 5.

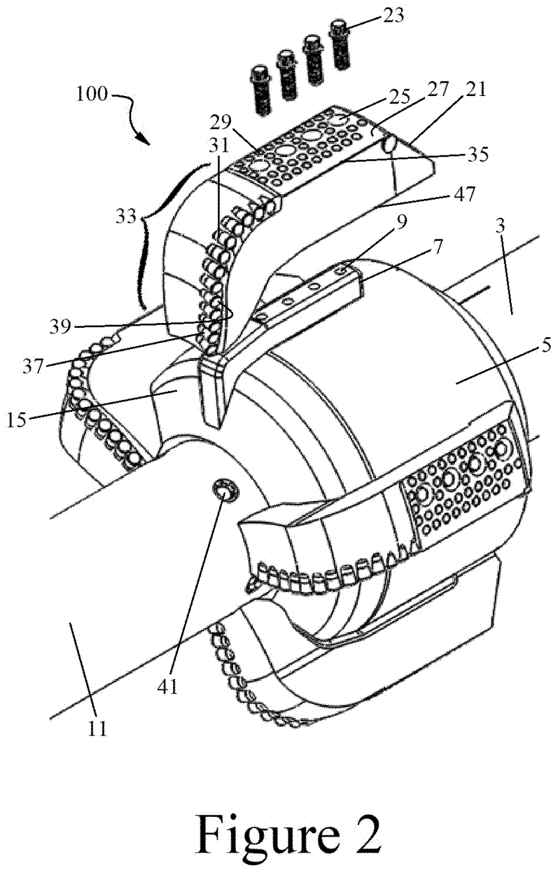

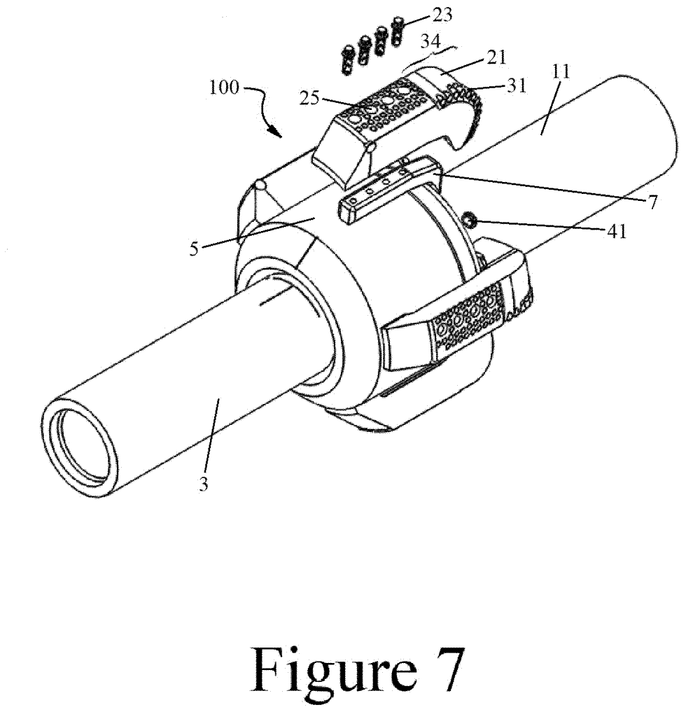

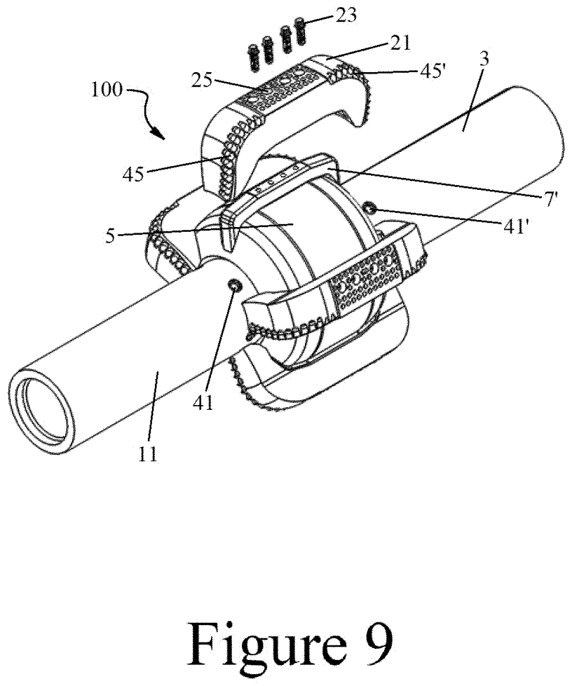

In one embodiment, one or more attachment members 7 comprise at least one attachment opening 9 disposed in an upper surface 17 thereof. As will be discussed in more detail with respect to FIG. 2 below, in one embodiment, openings 9 may comprise internal threading (not shown) which allows for screwed connection to attachment members 7. In the embodiment depicted in FIG. 1, attachment openings 9 are provided within a mid-section 19 of body 5, although the invention is not so limited and other arrangements may be employed. In the embodiment of FIG. 1, attachment members 7 extend beyond mid-section 19 of body 5 and wrap around onto downhole end 15 of body 5, along an exterior surface 22 thereof (But see, e.g., other embodiments in FIGS. 7 and 9, discussed below). Although in FIG. 1 attachment members 7 are depicted as comprising a single component, the invention is not so limited and an attachment member 7 may comprise a plurality of sub-components.

Referring now to FIG. 2, a partially exploded view of an embodiment of a reamer 100 of the present invention is depicted. As shown in the embodiment of FIG. 2, sub-body members 21 are attachable to attachment members 7 utilizing, as an example only, one or more bolts 23 that are adapted and configured to extend through bolt holes 25, that extend through sub-body members 7, and screwingly engage attachment openings 9. As would be understood by one skilled in the art, attachment means other than bolts 23 may be employed to reversibly attach sub-body members 21 to attachment members 7.

In one embodiment, one or more sub-body members 21 comprise a shape that mirrors that of the attachment members 7 to which they are reversibly connected; i.e., a sub-body member 21 may be comprise an approximately 90° bend whereby a portion of its bottom surface (not visible) can track the upper surface 17 of the attachment member 7, thereby providing a snug fit there between. In one embodiment, this snug fit comprises contact between a lower edge 47 of sub-body member 21 and at least a portion of an exterior surface of body 5 In such an embodiment, a sub-member 21, when attached to an attachment member 7, may extend along a portion of the exterior surface 13 of body 5 and along a portion of the downhole end 15 of body 5. Although in FIG. 2 sub-body members 21 are depicted as comprising a single component, the invention is not so limited and a sub-body member 21 may comprise a plurality of sub-components.

In the embodiment shown in FIG. 2, one or more sub-body members 21 may comprise an upper, outer exterior surface 27. Although in the embodiment of FIG. 2 upper, outer exterior surface 27 is depicted as substantially planar and oriented substantially parallel to axis A-A (see FIG. 3), the invention is not so limited and other geometries and/or orientations may be employed. In one embodiment, as described above, one or more bolt holes 25 extend through upper, outer exterior surface 27. In one embodiment, one or more abrasion-resistant members 29, are disposed along and/or partially within upper, outer exterior surface 27, as would be understood by one skilled in the art.

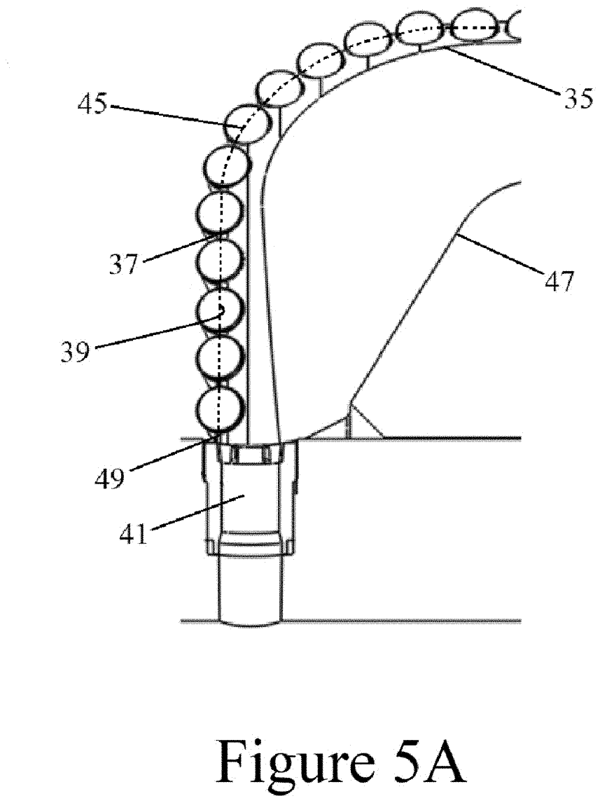

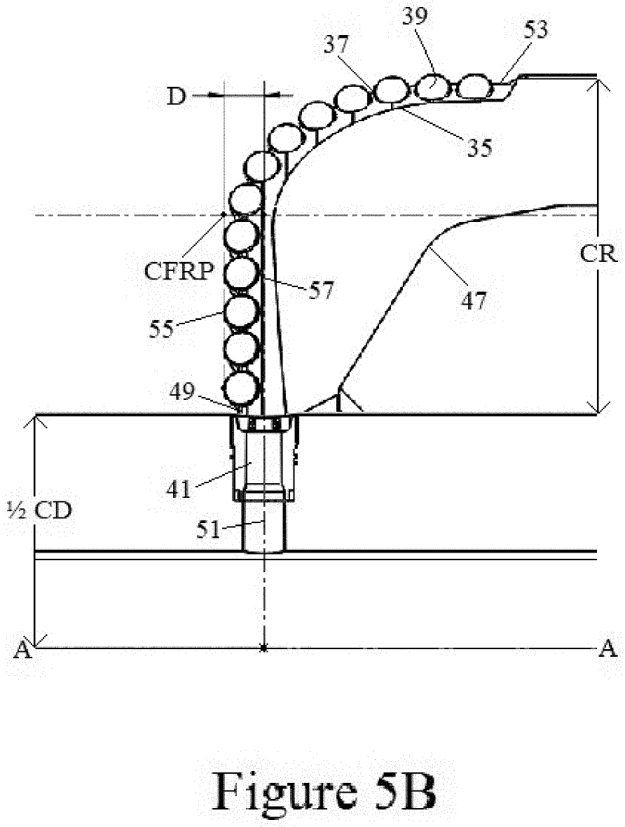

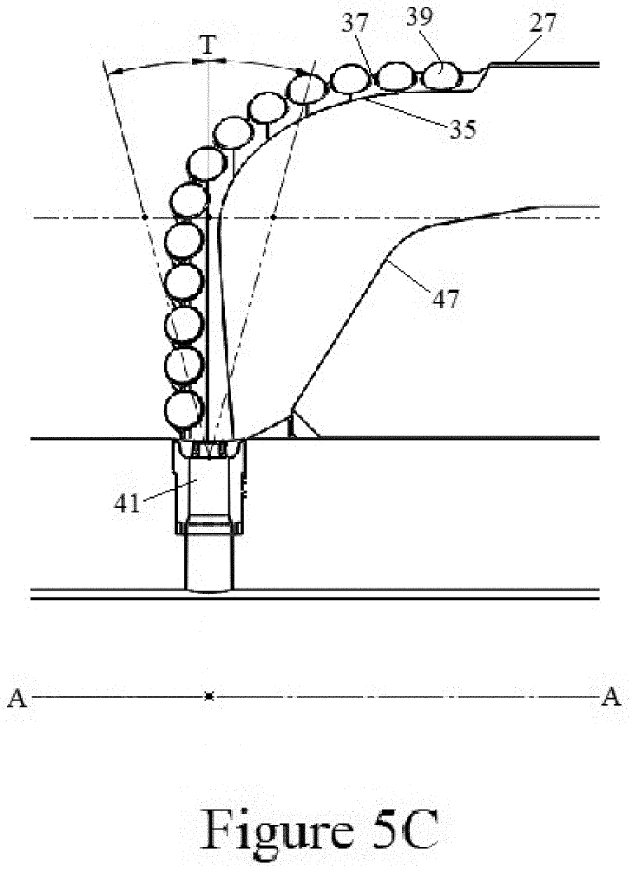

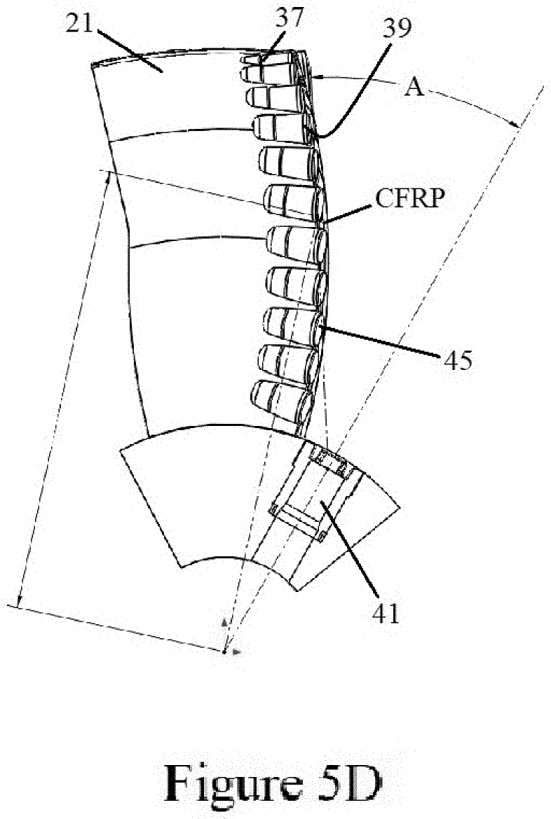

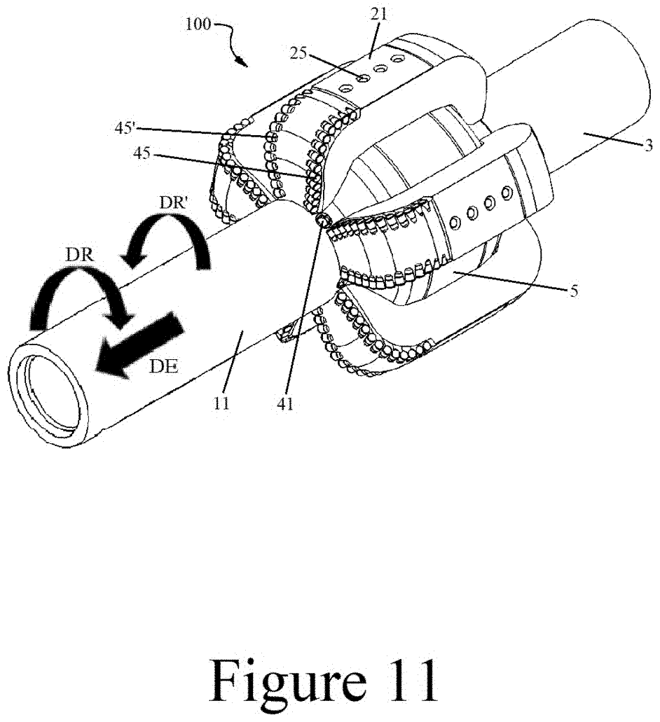

In one embodiment, as depicted in FIG. 2, at least one sub-body member 21 comprises one or more blades 31 disposed along at least a portion of a lower section 33 thereof, although the invention is not so limited and one or more blades 31 may be positioned, alternatively or additionally, at other locations on a sub-body member 21, such as, but not limited to, along a portion of an upper section 34 (see, e.g., FIG. 7). In other embodiments, a sub-body member 21 may be configured for attachment to an attachment member 7′, as depicted in FIGS. 9-12 and described below. In one embodiment, a blade 31 may be disposed proximate, along, and/or about an upper edge 35 of a sub-body member 21. In one embodiment, a blade 31 comprises a plurality of cutting elements 37, as are known in the art, although other cutting section architectures may be employed. In one embodiment, one or more cutting elements 37 each comprise one or more cutting tips 39. In one embodiment, a cutting element 37 cutting tip 39 may be oriented substantially perpendicular to the plane containing a cutting face 45 (see FIG. 5A). In one embodiment, a cutting element 37 cutting tip 39 may be oriented substantially perpendicular to the longitudinal axis of installed bolts 23. As is described in more detail below, a cutting element 37 is adapted and configured to excavate, and therefore outwardly concentrically expand, the bore when the reamer 100 is rotated and advanced within the bore. In one embodiment (not shown) a sub-body 21 configured for attachment to an attachment member 7 may comprise two cutting faces 45 disposed on either side of the sub-body 21 (similarl to cutting faces 45 shown in FIG. 11).

Still referring to FIG. 2, in one embodiment a reamer 100 comprises one or more nozzles 41 that are fluidly connected to at least a portion of an interior of the collar 11 (not separately labeled). In one embodiment, a nozzle 41 is at least partially disposed within the interior of the collar 11. In various embodiments, a nozzle 41 may comprise any suitable fluid projecting aperture or device that allows fluid to flow from the interior of the tool to the annulus in conventional circulation drilling, as would be understood by one skilled in the art. In one embodiment, a nozzle 41 may be disposed at least partially within collar 11 (see also FIG. 5), such that liquid flowed within the pipe can flow through a nozzle 41 and be directed as desired within the bore. In one embodiment, a nozzle 41 is disposed proximate a cutting element 37 such that fluid, such as, but not limited to, water, can be directed so as to contact at least a portion of a cutting element 37 proximate thereto. As would be understood by one skilled in the art, fluid (e.g., water) may be provided in this application at an elevated pressure. In one such embodiment, water flow through a nozzle 41 can be directed whereby water contacts at least one or more cutting tips 39. In one embodiment, as discussed in further detail below, water flow through a nozzle 41 can be directed tangentially along a series of cutting tips 39.

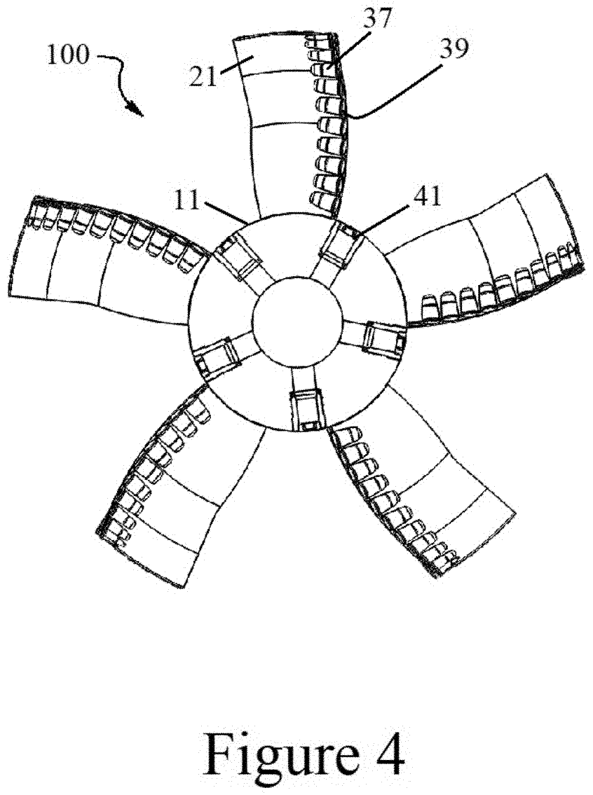

FIG. 3 depicts the embodiment of the reamer 100 of FIG. 2 wherein the disconnected sub-body member 21 has been reversibly attached to an attachment member 7 via screwed engagement of bolts 23 within corresponding bolt holes 25. As can be seen in FIG. 3, in this embodiment a nozzle 41 is disposed proximate a lower end 43 of upper edge 35 of sub-body member 21. In various embodiments, one or more nozzles 41 may be similarly disposed with respect to the sub-body member(s) 21 with which a reamer 100 is equipped, as depicted in FIG. 4.

Referring now to FIGS. 5A-5D, in one embodiment, as depicted in FIG. 5A, nozzle(s) 41 are oriented substantially perpendicular to the axis of rotation of the reamer during an excavation operation. In such an embodiment, a nozzle 41 is disposed such that a fluid flowing therethrough is expelled substantially parallel to a plane defined by the leading edge of the cutting blade 31. In one aspect, the leading edge of the cutting element 37 is defined herein as the “cutting face” 45, which is depicted in FIG. 5A as an (imaginary) dotted line which connects tangents at tips 39 of a cutting elements 37, commencing at the cutting tip 39 most proximate nozzle 41 (i.e., at proximal end 49 of cutting blade 31), and terminating at the cutting tip 39 most distant to nozzle 41 (i.e., at distal end 53 of cutting blade 31). In one embodiment, such nozzle orientation provides fluid flow along the cutting face 45 during reamer operation. Depicted in FIG. 5B are various reference measurements relating to various embodiments of certain components of a reamer 100. As identified therein, a width “D” which constitutes the distance between an up-hole proximal edge 57 of cutting blade 31 and a downhole proximal edge 55 of cutting blade 31. In one embodiment, a central axis 51 of the nozzle 41 extended, is substantially coextensive with a portion of up-hole proximal edge 57 of the cutting blade 31. In one embodiment, the central axis of a nozzle 41 is positioned, with respect to the portion of cutting face 45 most proximate thereto, at or within a maximum distance equal to two times the width D of the cutting blade 31. Also depicted in FIG. 5B is a distance “CR,” which identifies for a particular cutting blade 31 the effective cutting range of the reamer 100, and a “cutter-face reference point” (CFRP), whose position is identified along the cutting face 45. In one embodiment, the position of a CFRP is defined as about 0.5−0.6×(RD-CD)+CD, where CD is the pipe/collar diameter and RD is the diameter of the reamer body 5, or in other words, about 50-60% of the distance CR from proximal end 49 of cutting blade 31 to distal end 53 of cutting blade 31. In other embodiments (not shown), the specific curvature of a cutting blade 37 may be taken into account when determining a CFRP. In one aspect, the CFRP may be utilized as a reference point for determining the proper orientation of the nozzle and distance of the nozzle from the cutting blade 31, as shown in FIG. 5C & 5D.

In one embodiment, depicted in FIG. 5C, a nozzle 41 is disposed such that the spray angle of fluid directed from a nozzle 41, in a plane parallel to or coextensive with the plane comprising cutting face 45, encompasses a range of ±15° (arc “T”)with respect to the central axis 51 of nozzle 41, extended. FIG. 5D depicts the trajectory of nozzle 41 from a different angle of view, wherein a nozzle 41 trajectory with reference to the cutting face 45, in a plane perpendicular thereto, comprises an arc “A.” In one embodiment, arc A comprises an angle, with respect to the distal end 53 of cutting blade 31, of between about 28° and 40°.

Not to be bound by theory, it is believed that by directing fluid flow as described herein, the average velocity of the fluid at the interface of the rock and tangent to blade 31 is increased, resulting in improved cutting face 45 cleaning and a reduced occurrence of the cutting face 45 being “packed off” with cuttings; i.e., rock cuttings (debris) are more easily carried away from the face of the rock. In one aspect, a greater percentage of the cutting debris particles are fully encapsulated by the fluid, thereby reducing the amount of cutting debris that is typically mechanically captivated by the cutting structure. This results in smaller overall debris particle size, which in turn results in a reduction in the overall fluid energy required to manipulate the debris, and thus a more efficient flushing characteristic may be achieved. In operation, this makes the tool less likely to suffer from “bit balling,” which is an event in which debris particles from the drilling action collide together and collect near the area of which the cutting action is occurring. If bit balling occurs, it can proliferate to the extent of limiting or completely eliminating the reamer's ability to continue to cut the formation.

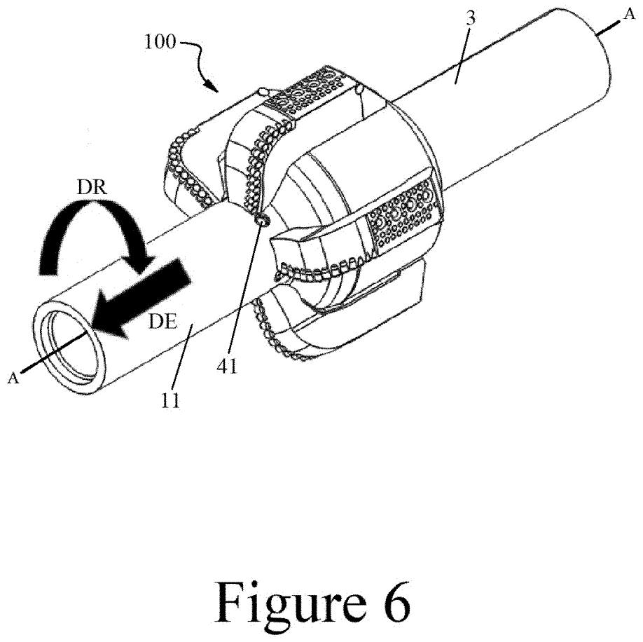

In another aspect of the present invention, a reamer 100 can be re-configured to allow for a change in the direction of excavation, i.e., from “pushing” to “pulling,” or vice versa. FIG. 6 depicts the movement of an embodiment of a reamer 100 of the present invention in one mode of operation. In the embodiment of FIG. 6, the rotation of the reamer 100 during excavation is indicated by the arrow labeled DR (for direction of rotation), and the direction of excavation is indicated by the arrow labeled DE (direction of excavation). As would be understood by one skilled in the art, rotation and excavation in the directions indicated in FIG. 6 would provide the cutting face 45 in proper position and orientation to excavate.

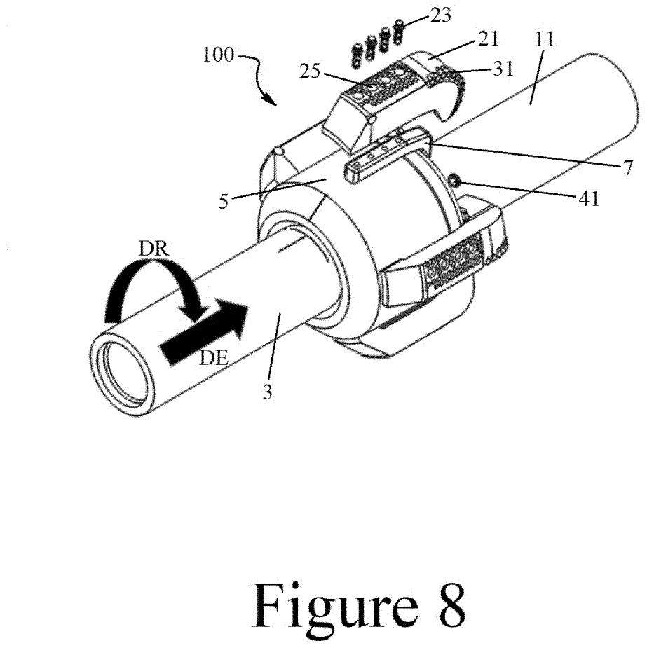

Referring now to FIG. 7, the reamer 100 has been rotated 180° about an axis running perpendicular to axis A-A and extending through the center of the reamer 100. As can be observed in FIG. 7, the visible nozzle 41 is now situated in an up-hole position. As shown in FIG. 7, the sub-body members 21 can be detached from the attachment members 7, and oppositely oriented sub-body members 21 can be reversibly attached to the attachment members 7. As depicted in FIG. 8, upon such attachment of sub-body members 21, reamer 100 is now configured to operate in an excavation direction opposite that shown in FIG. 6. In one embodiment, the relative dimensions of piping, nozzles 41 and sub-body members 21 are sized such that sub-body members 21 place their cutting faces 45 proximate nozzles 41 as described above.

In still another aspect of the present invention, a reamer 100 can be configured to allow for a change in the direction of excavation without the need for the interchange of components. As shown in one embodiment in FIG. 9, a reamer 100 may comprise one or more attachment members 7′, one or more sub-body members 21, and one or more of each of nozzles 41 and 41′. In one embodiment, an attachment member 7′ is affixed to, or integral with, body 5, wherein the attachment member 7′ extends transversely substantially completely across the exterior surface 13 of body 5, and bends around both the downhole end 15 of body 5 and an up-hole end of body 5 (not visible in FIG. 9). As with attachment members 7 described above, attachment members 7′ comprise bolt holes 9, which allow for reversible attachment of sub-body member 21 thereto utilizing bolts 23. As also shown in FIG. 9, in one embodiment, a sub-body member 21, similarly to attachment member 7′, extends transversely completely across the exterior surface 13 of body 5, and bends around both the downhole end 15 of body 5 and an up-hole end of body 5 (not visible in FIG. 9). In one embodiment, a sub-body member 21 comprises two cutting faces, 45 and 45′, which allow for excavating in either a pushing or pulling excavation direction. In one embodiment, an attachment member 7′ may be adapted and configured such a sub-body member 21 may be attached proximate a nozzle 41 and/or a sub-body member 21 may be attached proximate a nozzle 41′. As described above for attachment member 7, attachment member 7′ may comprise a single component or multiple sub-components. In addition, as described above for sub-body member 21 and sub-body member 21, sub-body member 21 may comprise a single component or multiple sub-components.

In one embodiment, as shown in FIG. 9, a reamer 100 may comprise one or more nozzles 41 disposed on the downhole pipe section 11, and one or more nozzles 41′ disposed on the up-hole pipe section 3. In such an embodiment, the relative dimensions of piping, nozzles 41 and sub-body members 21 are sized such that nozzles 41 and 41′ are disposed proximate downhole cutting faces 45 and up-hole cutting faces 45′, respectively, as described above. In one embodiment, a reamer 100 as depicted in FIG. 9 is adapted and configure to excavate if either pushed or pulled. In one embodiment, fluid is flowed through nozzle(s) 41 and fluid is blocked from flowing through nozzle(s) 41′ when reamer 100 is operated in a downhole direction, and fluid is flowed through nozzle(s) 41′ and fluid is blocked from flowing through nozzle(s) 41 when reamer 100 is operated in an up-hole direction.

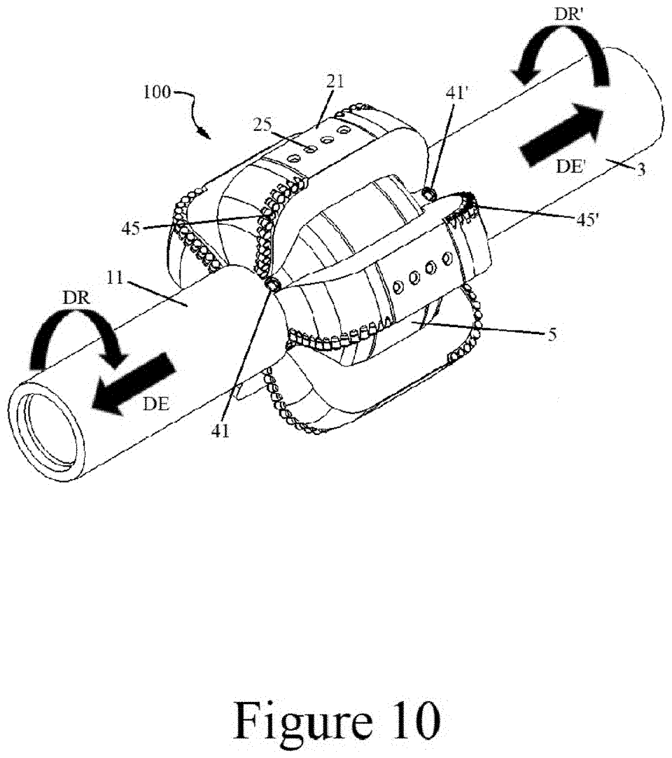

Depicted in FIG. 10 is another embodiment of a reamer of the present invention, wherein a sub-body 21 comprises a first cutting face 45 and an oppositely oriented second cutting face 45′. In one aspect, cutting face 45 is utilized for excavation when the direction of rotation (DR) and direction of excavation (DE) are as indicated in FIG. 10. In another aspect, cutting face 45′ is utilized for excavation when the opposite direction of rotation (DR′) and opposite direction of excavation (DE′) are employed, as indicated in FIG. 10. In one embodiment, this allows for excavation when reversal of both the direction of rotation and the direction of excavation is desired or necessary.

Depicted in FIG. 11 is another embodiment of a reamer of the present invention, wherein a sub-body 21 comprises a first cutting face 45 and an oppositely facing second cutting face 45′. In one aspect, cutting face 45 is utilized for excavation when the direction of rotation (DR) and direction of excavation (DE) are as indicated in FIG. 11. In another aspect, cutting face 45′ is utilized for excavation when the opposite direction of rotation (DR′) in the same direction of excavation (DE) are as indicated in FIG. 11. In one embodiment, this allows for excavation when reversal of the direction of rotation but not the direction of excavation is desired or necessary.

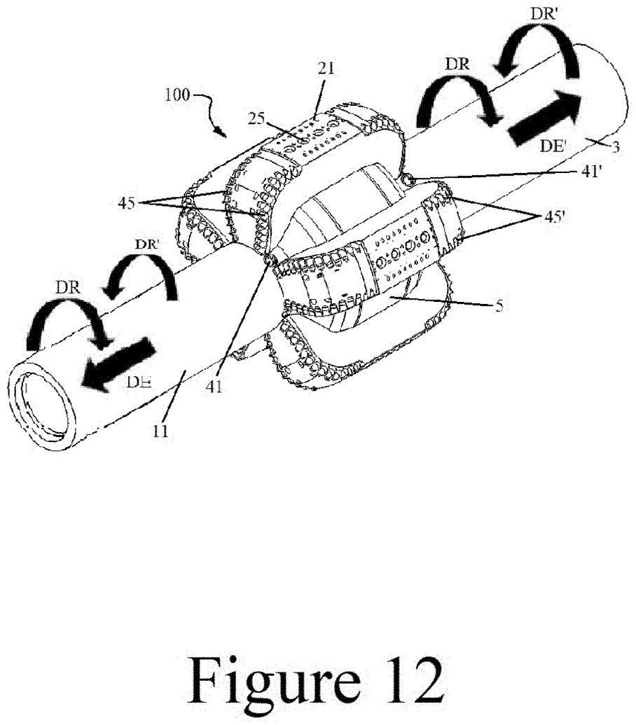

Depicted in FIG. 12 is another embodiment of a reamer of the present invention, wherein a sub-body 21 comprises a pair of oppositely facing cutting faces 45, and another pair of an oppositely facing cutting faces 45′. In one aspect, cutting faces 45 may be utilized for excavation when the direction of rotation (DR or DR′) and direction of excavation (DE) are as indicated in FIG. 12. In another aspect, cutting faces 45′ may be utilized for excavation when the direction of rotation (DR or DR′) and direction of excavation (DE′) are as indicated in FIG. 12. In one embodiment, this allows for excavation when reversal of the direction of rotation and/or the direction of excavation is desired or necessary.

### Method

In various embodiments, a method of utilizing embodiments of the present invention comprises the following steps:

A Reamer Provision Step, comprising providing a reamer, such as a reamer 100, wherein; the reamer comprises one or more attachment members, such as an attachment member 7, wherein attached to at least one attachment member is a sub-body member, such as a sub-body member 21, wherein at least one sub-body member comprises a blade, such as a blade 31, wherein at least one blade comprises one or more cutting elements, such as cutting element 37, and wherein the reamer comprises one or more nozzles, such as a nozzle 41, and at least one nozzle is positioned at least partially within a collar, such as a collar 11; and

A Reamer Operation Step, comprising introducing the reamer downhole and operating the reamer to expand the circumference of a hole, wherein fluid is flowed through at least one nozzle.

In other embodiments of the above-recited method, the method may comprise removing the reamer from the bore, reorienting it 180° with respect to a longitudinal axis of the reamer, such as axis A-A, and reintroducing the reamer to the bore to further excavate the bore in the opposite direction. In other embodiments, the method may comprise excavating the bore in the opposite direction and/or rotating the reamer in the opposite direction without removing the reamer from the bore.

### Operation

In operation, an embodiment of a reamer 100 of the present invention is provided in a pilot hole on a drill string (not separately labeled) comprising pipe (collar) sections 3 and 11; thereupon, the reamer 100 may be rotated and pulled back through, and/or pushed through, the pilot hole to enlarge the diameter thereof as may be desired. The reamer 100 is rotated by a rig or rigs (not shown) acting to impart axial and torsional force on the reamer 100 through the cutting element(s) 37 to the rock being cut. Regardless of the orientation of the reamer body 5, one or more cutting elements 37 are necessarily positioned on the leading face of the reamer 100 (i.e., the cutting face 45 being utilized during that portion of an excavating operation) defined by the direction of excavation and the direction of rotation of the drill string. This remains true whether the rig is pushing or pulling the reamer. Thus, two embodiments are envisaged to achieve reversibility—one where the reamer 100 itself is removed, positionally reversed, and cutting sub-bodies 21 are attached such that the cutting element(s) 37 face in the opposite direction, and another where the body 5 remains in the same position relative to the drill string, but the attachment member 7 and/or 7′ allows a cutting sub-body 21 cutting face 45 (and/or 45′) to be attached in either an up-hole or downhole excavating orientation. In both cases, the nozzle 41 and/or 41′ is positioned in such a way to transfer fluid from the internal diameter of the reamer 100 collar (3 and/or 11) to the exterior thereof.

While the present invention has been disclosed and discussed in connection with the foregoing embodiments, it will be understood that the invention is not limited to the embodiments disclosed, but is capable of numerous rearrangements, modifications, and substitutions of parts and elements without departing from the spirit and scope of the invention.

We claim:

1. A reamer for horizontal directional drilling comprising:
a body;
one or more attachment members; and
one or more sub-bodies;
wherein:
each attachment member is affixed to or integral to an exterior surface of said body;
each sub-body is reversibly attached to an attachment member; and
each sub-body comprises at least one cutting blade comprising one or more cutting elements.

2. The reamer for horizontal directional drilling of claim 1, wherein said reamer comprises a collar, and along said collar are disposed one or more nozzles fluidly connected to an interior of said collar.

3. The reamer for horizontal directional drilling of claim 2, wherein at least one said nozzle operates to direct a fluid provided to the interior of said collar toward at least one said cutting element.

4. The reamer for horizontal directional drilling of claim 3, wherein at least one said nozzle operates to direct a fluid provided to the interior of said collar toward a cutting tip of at least one said cutting element.

5. The reamer for horizontal directional drilling of claim 4, wherein at least one said nozzle operates to direct a fluid provided to the interior of said collar longitudinally alone a plurality of said cutting tips.

6. The reamer for horizontal directional drilling of claim 2, wherein a least one said nozzle is oriented to direct fluid flowing from the interior of said collar substantially parallel to a plane comprising a cutting face of said blade.

7. The reamer for horizontal directional drilling of claim 6, wherein said fluid is directed such that at least a portion of said fluid is flowed along at least a portion of said cutting face.

8. The reamer for horizontal directional drilling of claim 7, wherein a central axis of at least one said nozzle, extended, is substantially coextensive with a portion of an up-hole edge of said cutting blade.

9. The reamer for horizontal directional drilling of claim 8, wherein at least one said nozzle is positioned along said collar such that a central axis of that nozzle, extended, is disposed, in relation to said cutting face, a distance less than or equal to twice the diameter of said cutting blade.

10. The reamer for horizontal directional drilling of claim 7, wherein:
a reamer cutting range consists of a minimum distance between said collar and a cutting tip of a cutting element disposed at a distal end of said cutting blade;
a cutter-face refence point consists of a position along said cutting blade; and
the position of said cutter-face refence point, in relation to said distal end of said cutting blade, lies between about 0.5×(RD−CD)+CD and about 0.6×(RD−CD)+CD, wherein RD is the diameter of said reamer body and CD is the diameter of said collar.

11. The reamer for horizontal directional drilling of claim 7, wherein a spray angle of at least one said nozzle, in a plane parallel to or coextensive with said cutting face, comprises between about ±15° with respect to a central axis of that nozzle, extended.

12. The reamer for horizontal directional drilling of claim 7, wherein a spray angle of at least one said nozzle, in a plane perpendicular to said cutting face, comprises between about 28° and about 40° with respect to said distal end of said cutting blade.

13. The reamer for horizontal directional drilling of claim 1, wherein at least one said sub-body that is positioned to provide a cutting face thereof oriented for excavation in a first direction of excavation of said reamer when said reamer is rotated in a first direction of rotation may be replaced with another sub-body, wherein the replacement sub-body comprises a cutting face oriented to allow for excavation in a second direction of excavation of said reamer that is opposite said first direction of excavation and/or oriented to allow for excavation in a second direction of rotation of said reamer that is opposite said first direction of rotation.

14. The reamer for horizontal directional drilling of claim 1, wherein at least one said sub-body comprises two cutting faces oriented for excavation, whereby, when said reamer is rotated in one rotational direction, one said cutting face allows for excavation in a first direction of excavation of said reamer and the other said cutting face allows for excavation in a second direction of excavation of said reamer that is opposite said first direction.

15. The reamer for horizontal directional drilling of claim 1, wherein at least one said sub-body comprises two cutting faces oriented for excavation, whereby one said cutting face allows for excavation in a first direction of excavation of said reamer when said reamer is operated in a first direction of rotation and the other said cutting face allows for excavation in a second direction of excavation of said reamer that is opposite said first direction of excavation when said reamer is operated in a second direction of rotation that is opposite said first direction of rotation.

16. The reamer for horizontal directional drilling of claim 1, wherein at least one said sub-body comprises two cutting faces oriented for excavation, whereby one said cutting face allows for excavation in a direction of excavation of said reamer when said reamer is operated in a first direction of rotation and the other said cutting face allows for excavation in the same direction of excavation of said reamer when said reamer is operated in a second direction of rotation that is opposite said first direction of rotation.

17. The reamer for horizontal directional drilling of claim 1, wherein at least one said sub-body comprises four cutting faces oriented for excavation, wherein:
a first said cutting face allows for excavation in a first direction of excavation of said reamer when said reamer is operated in a first direction of rotation;
a second said cutting face allows for excavation in a second direction of excavation of said reamer when said reamer is operated in a first direction of rotation;
a third said cutting face allows for excavation in a first direction of excavation of said reamer when said reamer is operated in a second direction of rotation; and
a fourth said cutting face allows for excavation in a second direction of excavation of said reamer when said reamer is operated in a second direction of rotation.

18. A method of using a reamer for horizontal directional drilling comprising:
providing reamer for horizontal directional drilling, said reamer comprising:
a body;
one or more attachment members; and
one or more sub-bodies;
wherein:
each attachment member is affixed to or integral to an exterior surface of said body;
each sub-body is reversibly attached to an attachment member; and
each sub-body comprises at least one cutting blade comprising one or more cutting elements.; and
operating said reamer to enlarge the diameter of a subsurface hole.

19. The method of using a reamer for horizontal directional drilling of claim 18, wherein said reamer comprises a collar, and along said collar are disposed one or more nozzles fluidly connected to an interior of said collar.

20. The method of using a reamer for horizontal directional drilling of claim 18, comprising:
operating said reamer in a first direction of rotation to enlarge the diameter of said subsurface hole; and
operating said reamer in a second direction of rotation to enlarge the diameter of said subsurface hole, wherein said second direction of rotation is opposite said first direction of rotation.

21. The method of using a reamer for horizontal directional drilling of claim 18, comprising:
operating said reamer in a first direction of excavation to enlarge the diameter of said subsurface hole; and
operating said reamer in a second direction of excavation of excavation to enlarge the diameter of said subsurface hole, wherein said second direction of excavation is opposite said first direction of excavation.
